(19) United States
(12) Patent Application Publication
(10) Pub. No.: US 2021/0277312 A1
(43) Pub. Date: Sep. 9, 2021

(54) PLASTIC MATERIAL VAPORIZING DEVICE, AND DEVICE AND METHOD FOR EXTRACTING HYDROCARBON COMPOUND FROM PLASTIC MATERIAL

(71) Applicant: X-BRAIN CO., LTD., Tokyo (JP)

(72) Inventors: Ryuichiro Shikanai, Singapore (SG); Masamichi Kikuchi, Tokyo (JP)

(21) Appl. No.: 17/261,268

(22) PCT Filed: Jul. 22, 2019
(86) PCT No.: PCT/JP19/28647

§ 371 Date: Jan. 19, 2021

(30) Foreign Application Priority Data
Jul. 20, 2018 (JP) 2018-136987
Jan. 31, 2019 (JP) 2019-015437

(51) Int. Cl. C10G 1/10

(52) U.S. Cl. CPC C10G 1/10; C10G 2300/10

(57) ABSTRACT

A plastic material vaporizing device (10) in accordance with an aspect of the present invention generates fuel from a plastic material. The plastic material vaporizing device (10) includes: a container (7) configured to heat and vaporize the plastic material; and stirring blades (1a to 1d) configured to rotate in the container (7), the stirring blades (1a to 1d) each having at least one curved surface facing an upper side of the container (7) in a cross section of each of the stirring blades (1a to 1d), and the at least one curved surface preventing the plastic material from adhering to each of the stirring blades (1a to 1d).

### TECHNICAL FIELD

The present invention relates to a plastic material vaporizing device.

### BACKGROUND ART

There has been known, for the purpose of separating a plurality of hydrocarbon components constituting a plastic material, a plastic material vaporizing device which vaporizes a plastic material by heating the plastic material. Such a device generally includes, in a heating container, a stirring plate for stirring the plastic material so as to evenly distribute heat to the plastic material (Patent Literatures 1 to 3).

### CITATION LIST

### Patent Literature

[Patent Literature 1]

Japanese Patent Application Publication Tokukaihei No. 9-95678 (Publication date: Apr. 8, 1997)

[Patent Literature 2]

Japanese Patent Application Publication Tokukaihei No. 7-37621 (Publication date: Apr. 26, 1995)

[Patent Literature 3]

Japanese Patent Application Publication Tokukaihei No. 7-74338 (Publication date: Aug. 9, 1995)

### SUMMARY OF INVENTION

### Technical Problem

The stirring plate in a device as described above generally has a cross section of a flat plate or an L-shaped cross section. The stirring plate having the cross section of a flat plate cannot sufficiently stir the plastic material which has been melted by heating. On the other hand, the stirring plate having the L-shaped cross section deprives the plastic material of heat since the plastic material which has been melted is caught, for a long time, by a hook-like portion of the stirring plate having the L-shaped cross section.

An object of an aspect of the present invention is to provide a plastic material vaporizing device, which is capable of evenly distributing heat to a plastic material having been melted while the plastic having been melted is not caught by the device more than necessary.

### Solution to Problem

In order to achieve the above object, a plastic material vaporizing device in accordance with an aspect of the present invention includes: a container having a cylindrical portion at an upper part thereof and an inverted cone portion or inverted truncated cone portion at a lower part thereof; a shaft extending from the upper part to the lower part in the container; and four stirring blades which rotate around the shaft, the four stirring blades being divided into two sets each including two stirring blades, and provided along a plane passing the shaft, the two stirring blades in each of the two sets extending in a direction opposite to each other from the shaft at a center, one of the two sets of the stirring blades being connected to the shaft at a position closer to a lower end of the shaft than a position where another one of the two sets of the stirring blades are connected to the shaft, the two stirring blades in each of the two sets being arranged such that: (a) with regard to respective cross sections of the two stirring blades, the two stirring blades each have a curved convex surface and a curved concave surface, the curved concave surface of one of the stirring blades facing in a direction opposite to a direction in which the curved convex surface of the one of the stirring blades faces, the curved concave surface of each of the two stirring blades facing forward in rotation of the stirring blades; or (b) with regard to respective cross sections of the two stirring blades, the two stirring blades each have a semicircular cross section, one of the two stirring blades having a flat surface facing forward in rotation of the stirring blades, the flat surface corresponding to a flat portion of the semicircular cross section, and another one of the two stirring blades having an arc of the semicircular cross section which arc faces the upper part of the container.

### Advantageous Effects of Invention

An aspect of the present invention makes it possible to evenly distribute heat to a plastic material having been melted while the plastic material having been melted is not caught more than necessary.

### BRIEF DESCRIPTION OF DRAWINGS

FIG. 1 is a diagram illustrating a configuration of a device in accordance with an embodiment of the present invention. FIG. 1 includes: a cross sectional view 1010 of a whole device; a cross sectional view 1020 of four stirring blades, taken along A-A′ and B-B′ in the cross sectional view 1010; and an enlarged perspective view 1030 of an inlet 3.

FIG. 2 is a diagram illustrating a configuration of a device in accordance with another embodiment of the present invention.

### DESCRIPTION OF EMBODIMENTS

[Plastic Material Vaporizing Device]

An embodiment of the present invention relates to a plastic material vaporizing device. The vaporizing device includes: a container having a cylindrical portion at an upper part thereof and an inverted cone portion or inverted truncated cone portion at a lower part thereof; a shaft extending from the upper part to the lower part in the container; and four stirring blades which rotate around the shaft, the four stirring blades being divided into two sets each including two stirring blades, and provided along a plane passing the shaft, the two stirring blades in each of the two sets extending in a direction opposite to each other from the shaft at a center, one of the two sets of the stirring blades being connected to the shaft at a position closer to a lower end of the shaft than a position where another one of the two sets of the stirring blades are connected to the shaft, the two stirring blades in each of the two sets being arranged such that: (a) with regard to respective cross sections of the two stirring blades, the two stirring blades each have a curved convex surface and a curved concave surface, the curved concave surface of one of the stirring blades facing in a direction opposite to a direction in which the curved convex surface of the one of the stirring blades faces, the curved concave surface of each of the two stirring blades facing forward in rotation of the stirring blades; or (b) with regard to respective cross sections of the two stirring blades, the two stirring blades each have a semicircular cross section, one of the two stirring blades having a flat surface facing forward in rotation of the stirring blades, the flat surface corresponding to a flat portion of the semicircular cross section, and another one of the two stirring blades having an arc of the semicircular cross section which arc faces the upper part of the container.

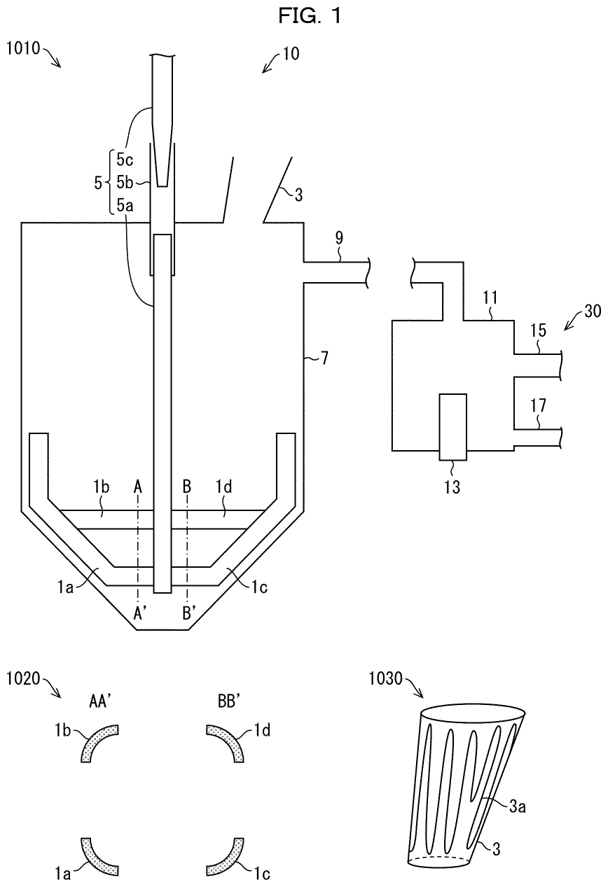

The following will discuss an example of the vaporizing device (particularly, in the case of the above (a)), with reference to FIG. 1. FIG. 1 includes: a cross sectional view 1010 of a whole device; a cross sectional view 1020 of four stirring blades, taken along A-A′ and B-B′ in the cross sectional view 1010; and an enlarged perspective view 1030 of an inlet 3.

The vaporizing device 10 includes a container 7 for vaporizing a plastic material by heating. The container 7 contains an octagonal prism 5a (shaft), and four stirring blades 1a to 1c which are connected to the octagonal prism 5a. At a top panel of the container 7, the inlet 3 is provided. Meanwhile, the container 7 is provided with a tube 9 at an upper part of a wall surface of the container 7. The tube 9 guides, to a condenser 30, gas generated by heating the plastic material. The octagonal prism 5a has its upper end portion inserted into a joint 5b from below the joint 5b. The joint 5b has an octagonal inner surface.

A drive shaft 5c has an octagonal cross section. The drive shaft 5c has a lower end portion inserted into the joint 5b from above the joint 5b prior to an operation of the vaporizing device 10. As illustrated in the cross sectional view 1010 of FIG. 1, the lower end portion of the drive shaft 5c is an inverted octagonal truncated pyramid (tapered) portion whose cross sectional area becomes smaller towards a lower end tip. The cross section of the octagonal prism 5a and the cross section of the drive shaft 5c each have a regular octagonal shape. The cross section of the octagonal prism 5a has an area substantially equal to that of the cross section of the drive shaft 5c. The inner surface of the joint 5b also has an octagonal shape. The joint 5b has an inner cross section whose area is slightly larger than those of the cross sections of the octagonal prism 5a and the drive shaft 5c. Accordingly, when the drive shaft 5c is partially inserted into an octagonal opening at an upper part of the joint 5b and then gradually lowered, the center of the octagonal prism 5a coincides with the center of the drive shaft 5c. Then, wall surfaces of the octagonal prism 5a coincide with respective wall surfaces of the drive shaft 5c. The inverted octagonal truncated pyramid portion of the drive shaft 5c slides and rotates with respect to the inner surface of the joint 5b, so that a misalignment between the inverted octagonal truncated pyramid portion of the drive shaft 5c and the inner surface of the joint 5c is corrected by a weight of the drive shaft 5c.

Though not illustrated in FIG. 1, the drive shaft 5c is connected to a power such as a motor, and transmits rotation energy from the power source to the stirring blades 1a to 1d via the joint 5b and the octagonal prism 5a. The container 7 is covered by a furnace which utilizes burning of liquid hydrocarbon fuel, up to at least a height to which the stirring blades 1a and 1c extend.

As illustrated in the enlarged perspective view 1030 of FIG. 1, the inlet 3 for the plastic material has, at the top thereof, a wide opening and, at the bottom thereof, an opening smaller than the wide opening. The inlet 3 has an outer diameter of a substantially inverted truncated cone. The inlet 3 has a peripheral surface provided, along a direction of an axis of the inverted truncated cone, with a conductive resistive heating wire 3a which is undulating. No member is provided so as to cover the resistive heating wire 3a and the peripheral surface of the inlet 3. In the case of the inlet 3 of the above example, in order to prevent excessive heating and fall of the resistive heating wire 3a due to excessive heating, the resistive heating wire 3a is not wound in a circumferential direction of the inlet 3. For the same purpose, the resistive heating wire 3a is covered by no member which may hinder heat dissipation from the resistive heating wire 3a.

The temperature inside the inlet 3 is kept at approximately 300° C. to 400° C. (temperature slightly higher than the melting point of a synthetic resin which will be described later), by heat received from the resistive heating wire 3a. The plastic material introduced from the top of the inlet 3 partially melts, receiving heat from a wall surface of the inlet 3. The plastic material having melted flows along the wall surface of the inlet 3 and reaches in the vicinity of the bottom of the inlet 3. The (low-viscosity) plastic material which has completely melted falls into the container 7. In contrast, the (high-viscosity) plastic material which has partially melted stays in the vicinity of the bottom of the inlet until the viscosity of the plastic material becomes sufficiently low. The opening formed at the bottom of the inlet 3 is provided with no open-close member such as a valve. This is because the high-viscosity plastic material which is staying in the vicinity of the bottom of the inlet 3 functions to block the opening. Therefore, most components of the plastic material which has vaporized in the container 7 are not released out of the vaporizing device 10 through the opening.

The temperature inside the container 7 is selected from temperatures at which the plastic material is partially vaporized. Meanwhile, the temperature inside the container 11 is selected from temperatures at which the components of the plastic material having been vaporized in the container 7 are partially condensed. In one example, the temperature inside the container 7 of the vaporizing device 10 is kept at 400° C. to 500° C. by heat received from the furnace. Meanwhile, the temperature inside the container 11 of the condenser 30 is kept at lower than 400° C. In another example, the temperature inside the container 7 of the vaporizing device 10 is kept at 350° C. to 450° C. by heat received from the furnace. Meanwhile, the temperature inside the container 11 of the condenser 30 is kept at lower than that inside the container 7. In either of the above examples, most components of the plastic material which has vaporized in the container 7 are not released through the inlet 3, as described above, but are guided to the container 11 through the tube 9.

The plastic material having fallen through the opening at the bottom of the inlet 3 stays in an inverted truncated cone portion of the container 7. Then, the plastic material receives further heat from the furnace via the inverted truncated cone portion. The plastic material having fallen into the container 7 through the opening of the inlet 3 is hardly caught by the stirring blades 1a to 1d (in particular, 1b and 1d). This is because, as illustrated in the cross sectional view 1020 of FIG. 1, the stirring blades 1b and 1d each have a convex curved surface which faces from the top of the container 7 to the wall surface of the container 7. The plastic material having fallen on the convex curved surface slides down on this convex curved surface and reaches the bottom of the container 7.

The plastic material, which has accumulated in the inverted truncated cone portion of the container 7, is then stirred by axial rotation of the stirring blades 1a to 1d. This allows the plastic material to substantially evenly receive heat from the inverted truncated cone portion. When the stirring blades 1a to 1d axially rotate, the plastic material being stirred is hardly caught by the stirring blades 1a to 1d (in particular, 1a and 1c). This is because, as illustrated in the cross sectional view 1020 of FIG. 1, the stirring blades 1a and 1c each have a concave curved surface which faces from the top of the container 7 to the wall surface of the container 7. For example, as a result of axial rotation of the stirring blade 1a (move of the stirring blade 1a toward the right side in FIG. 1), the plastic material being stirred slides on the concave curved surface, lifted on the concave curved surface, and then moves behind the stirring blade 1a.

While the plastic material is being stirred, the axial rotation of the stirring blades 1a to 1d eliminates, into the inverted truncated cone portion, a solid matter which has mixed in the plastic material (e.g., metal which does not melt at approximately 500° C.). The solid matter which does not melt or vaporize slips off from the stirring blades 1a to 1d more easily than the plastic material which has melted. Then, the solid matter gradually settles to the bottom of the container 7.

As described above, efficiently vaporized components from the plastic material, which have been uniformly stirred in the container 7, are not released outside through the inlet 3, but reach the container 11 of the condenser 30 through the tube 9.

The condenser 30 includes the container 11, a heater 13, and tubes 15 and 17. After the vaporized components reaches the container 11 from the vaporizing device 10, the vaporized components are partially condensed and extracted as liquid hydrocarbon via the tube 17. Components which have not condensed are transferred to another condenser (not illustrated) via the tube 15. Alternatively, the liquid hydrocarbon can be vaporized again by heating with the use of the heater 13 and then, transferred to still another condenser. In this case, the liquid hydrocarbon is not extracted through the tube 17. In the present example, although the heater 13 is provided vertically (from the bottom to the top of the container 11), the heater 13 can be alternatively provided horizontally (inward from a lateral surface of the container 11). Note that the liquid hydrocarbon extracted through the tube 17 can be utilized for burning in the furnace which covers a bottom portion of the vaporizing device 10.

The plastic material can be any of various materials containing synthetic resin (e.g., polypropylene (PP), polystyrene (PS), polyethylene terephthalate (PET), and polyethylene (PE)). In view of efficient use of waste materials, the plastic material is preferably a material collected from a waste material.

[Apparatus for Extracting Hydrocarbon Compound From Plastic Material]

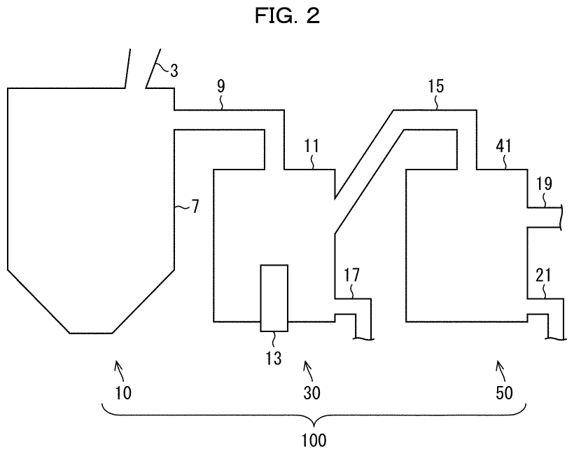

Another embodiment of the present invention is an apparatus for extracting a hydrocarbon compound from a plastic material (hereinafter, referred to as an extracting apparatus). The extracting apparatus includes a vaporizing device (the vaporizing device 10 illustrated in FIG. 1) and two cooling tanks. The extracting apparatus utilizes the condenser 30 illustrated in FIG. 1, as one of the cooling tanks (primary cooling tank). The following will discuss the extracting apparatus in accordance with the present embodiment, with reference to FIG. 2. Note that the following will discuss only points which do not overlap the above description with reference to FIG. 1.

As illustrated in FIG. 2, an extracting apparatus 100 includes the vaporizing device 10, the cooling tank 30 (primary cooling tank) and a cooling tank 50 (secondary cooling tank). The vaporizing device 10 is connected to the cooling tank 30 via the tube 9, and the cooling tank 30 is connected to the cooling tank 50 via the tube 15. The cooling tank 50 is cooled by a cooling medium (e.g., water) (not illustrated) while the extracting apparatus 100 is being operated. Accordingly, in a case where tubes 17 and 21 are closed and the tube 19 is opened while the extracting apparatus 100 is being operated, gas, which has reached the cooling tank 30 through the tube 9 from the vaporizing device 10, further reaches the cooling tank 50 through the tube 15.

The extracting apparatus 100 carries out two operation modes in rough classification. The heater 13 is operated in an operation mode a, whereas the heater 13 is not operated in an operation mode b. Therefore, an extracting apparatus 100 which carries out only the operation mode b does not need to include the heater 13.

In the operation mode a, the cooling tank 30 is kept, by heat provided by the heater 13, at a temperature which is lower than that in the vaporizing device 10 and higher than that in the cooling tank 50. Further, in the operation mode a, the gas transferred from the vaporizing device 10 (whose temperature is the highest) is cooled step by step via the cooling tank 30 (whose temperature is the second highest) and the cooling tank 50 (whose temperature is the lowest). Among the gas which has reached the cooling tank 30 from the vaporizing device 10, hydrocarbons each having a high boiling point stay in the cooling tank 30. As the temperature in the cooling tank 30 is increased so as to be closer to that in the vaporizing device 10, hydrocarbons having a higher boiling point pass the cooling tank 30 and reach the cooling tank 50. The hydrocarbons having reached the cooling tank 50 partially condense and remaining hydrocarbons which have not condensed are extracted out of the extracting apparatus 100 through the tube 19.

In the operation mode b, the cooling tank 30 is not heated and both of the cooling tanks 30 and 50 are cooled by a cooling medium. Accordingly, the cooling tank 30 in the operation mode b is kept at a temperature much lower than that in the cooling tank 30 in the operation mode a (e.g., at a temperature substantially equal to that in the cooling tank 50). In the operation mode b, when the gas reaches the cooling tank 30 from the vaporizing device 10, the gas is rapidly cooled. Then, hydrocarbons having a high boiling point to a relatively low boiling point condense and stay in the cooling tank 30. The hydrocarbons having reached the cooling tank 50 partially condense, and remaining hydrocarbons which have not condensed are extracted out of the extracting apparatus 100 through the tube 19.

The temperatures in the cooling tanks 30 and 50 differ between the operation modes a and b. Also, the amount and the composition of gas hydrocarbon extracted out of the extracting apparatus 100 differ between the operation modes a and b. As compared to the operation mode b, (i) it is possible to obtain a larger amount of gas hydrocarbon in the operation mode a, and (ii) it is also possible to obtain gas hydrocarbons having a larger number of carbon atoms in the operation mode a. Conversely, as compared to the operation mode a, (i) it is possible to obtain a larger amount of liquid hydrocarbon in the operation mode b, and (ii) it is also possible to obtain liquid hydrocarbons having a larger number of carbon atoms in the operation mode b. In the operation mode a, the gas from the vaporizing device 10 is exposed to a low temperature (in the cooling tank 50) for a shorter period of time. On the other hand, in the operation mode b, the gas from the vaporizing device 10 is exposed to a low temperature (in the cooling tank 30 and the cooling tank 50) for a longer period of time.

The operation mode a is suitable for an application in which generated gas is fed to an installed furnace (e.g., a waste incinerator and a power generation furnace), since it is possible obtain a large amount of gas hydrocarbons each having a high combustion calorie (having a large number of carbon atoms). The operation mode b is suitable for an application in which generated liquid is fed to a moving furnace (e.g., engines for vehicles and ships), since it is possible obtain a large amount of liquefied hydrocarbons suitable for storage and transportation.

In either of the operation modes a and b, the cooling tank 30 is set at a temperature lower than that of the container 7 of the vaporizing device 10. Components having been vaporized in the container 7 flow into the cooling tank 30 at a lower temperature through the tube 9. As described above, the vicinity of the bottom of the inlet 3 is blocked by the high-viscosity plastic material (which has partially melted). Accordingly, satisfying the following (1) to (3) allows a fluid in the extracting apparatus 100 to flow in a constant direction and at a constant flow rate.

(1) Continuously introduce, into the inlet 3, the plastic material substantially equal in amount to the plastic material falling into the container 7 from the inlet 3.

(2) Keep the cooling tank 30 at a temperature lower than that inside the container 7.

(3) Extract, through the tubes 17, 19, and 21, a product (gas and liquid) in an amount corresponding to that of gas vaporized per unit time in the container 7.

In the extracting apparatus 100 illustrated in FIG. 2, the cooling tanks 30 and 50 have the same inner volume. Particularly in the operation mode a, the volume of gas which condenses in the cooling tank 30 is smaller than that in the operation mode b and the volume of gas reaching the cooling tank 50 is larger than that in the operation mode b. When the operation mode a is carried out, the cooling tank 50 should have an inner volume which allows a relatively-large volume of gas to be processed.

[Method of Extracting Hydrocarbon Compound From Plastic Material]

An embodiment of the present invention relates to a method of extracting a hydrocarbon compound from a plastic material. The method is carried out by using the above-described extracting apparatus (that is, the apparatus illustrated as an example in FIG. 2). The method includes the steps of:

introducing a plastic material into the inlet 3;

fluidizing part of the plastic material by heating the inlet 3;

vaporizing a hydrocarbon compound contained in the plastic material in the container 7, by (a) heating the plastic material which has been fluidized, concurrently with (b) stirring the plastic material by use of the stirring blades 1a to 1d; and

transferring the hydrocarbon compound vaporized, to the primary cooling tank (cooling tank 30) and the secondary cooling tank (cooling tank 50) which are kept at a temperature lower than the container 7.

Therefore, the details of the above method overlaps the descriptions of the above [Plastic material vaporizing device] and [Apparatus for extracting hydrocarbon compound from plastic material], and thus will not be repeated here.

### INDUSTRIAL APPLICABILITY

The present invention is applicable to processing of a plastic material (in particular, waste plastic).

### REFERENCE SIGNS LIST

1a to 1d stirring blade

3 inlet

3a resistive heating wire (resistive heating section)

5 shaft

5a octagonal prism (shaft)

5b joint (cylindrical joint)

5c drive shaft

7, 11, 41 container

9, 15, 17, 19, 21 tube

10 vaporizing device (plastic material vaporizing device)

13 heater

30 condenser, cooling tank (primary cooling tank)

50 cooling tank (secondary cooling tank)

100 extracting apparatus (apparatus for extracting hydrocarbon compound from plastic material

1. A plastic material vaporizing device, comprising:
a container having a cylindrical portion at an upper part thereof and an inverted cone portion or inverted truncated cone portion at a lower part thereof;
a shaft extending from the upper part to the lower part in the container; and
four stirring blades which rotate around the shaft,
the four stirring blades being divided into two sets each including two stirring blades, and provided along a plane passing the shaft, the two stirring blades in each of the two sets extending in a direction opposite to each other from the shaft at a center, one of the two sets of the stirring blades being connected to the shaft at a position closer to a lower end of the shaft than a position where another one of the two sets of the stirring blades are connected to the shaft,
the two stirring blades in each of the two sets being arranged such that:
(a) with regard to respective cross sections of the two stirring blades, the two stirring blades each have a curved convex surface and a curved concave surface, the curved concave surface of one of the stirring blades facing in a direction opposite to a direction in which the curved convex surface of the one of the stirring blades faces, the curved concave surface of each of the two stirring blades facing forward in rotation of the stirring blades; or
(b) with regard to respective cross sections of the two stirring blades, the two stirring blades each have a semicircular cross section, one of the two stirring blades having a flat surface facing forward in rotation of the stirring blades, the flat surface corresponding to a flat portion of the semicircular cross section, and another one of the two stirring blades having an arc of the semicircular cross section which arc faces the upper part of the container.

2. A plastic material vaporizing device as set forth in claim 1, further comprising:
an inlet at a top panel of the cylindrical portion, the inlet having an inverted truncated cone shape,
the inlet being provided with a resistive heating section on an outer wall surface of the inlet, the outer wall surface lying along a direction of an axis of the inverted truncated cone shape.

3. A plastic material vaporizing device as set forth in claim 1, further comprising:
a furnace which externally heats the inverted cone portion or inverted truncated cone portion; and
a flow channel connected to a second container.

4. A plastic material vaporizing device as set forth in claim 1, further comprising:
a cylindrical joint having an octagonal inner surface; and
a drive shaft transmitting power to the cylindrical joint by axial rotation thereof,
the shaft and the drive shaft each having an octagonal prism shape, the shaft having (i) an upper end portion inserted into the cylindrical joint from below the cylindrical joint and (ii) the drive shaft being inserted into the cylindrical joint from above the cylindrical joint, the drive shaft having a lower end portion which has an inverted octagonal pyramid shape or inverted octagonal truncated pyramid shape.

5. An apparatus for extracting a hydrocarbon compound from a plastic material, comprising:
a plastic material vaporizing device as recited in claim 1;
a primary cooling tank;
a secondary cooling tank;
an inlet at a top panel of the cylindrical portion, the inlet having an inverted truncated cone shape; and
a resistive heating section provided, on an outer wall surface of the inlet, the outer wall surface lying along a direction of an axis of the inverted truncated cone shape,
(1) the container being connected to the primary cooling tank via a flow channel, and (2) the primary cooling tank being connected to the secondary cooling tank via another flow channel.

6. The apparatus as set forth in claim 5, wherein:
the primary cooling tank includes a heating section.

7. The apparatus as set forth in claim 5, wherein:
the secondary cooling tank is cooled by a cooling medium.

8. A method of extracting a hydrocarbon compound from a plastic material by use of the apparatus as set forth in claim 5, comprising the steps of:
introducing the plastic material into the inlet;
fluidizing part of the plastic material by heating the inlet;
vaporizing the hydrocarbon compound contained in the plastic material in the container, by (a) heating the plastic material which has been fluidized, concurrently with (b) stirring the plastic material by use of the stirring blades; and
transferring the hydrocarbon compound vaporized, to the primary cooling tank and the secondary cooling tank which are kept at a temperature lower than the container.
